(19) United States
(12) Patent Application Publication
(10) Pub. No.: US 2025/0296338 A1
(43) Pub. Date: Sep. 25, 2025

(54) INKJET RECORDING APPARATUS

(71) Applicant: KYOCERA Document Solutions Inc., Osaka (JP)

(72) Inventors: Tatsuhiko YOSHII, Osaka (JP); Takashi MORITA, Osaka (JP)

(73) Assignee: KYOCERA Document Solutions Inc., Osaka (JP)

(21) Appl. No.: 19/077,987

(22) Filed: Mar. 12, 2025

(30) Foreign Application Priority Data
Mar. 22, 2024 (JP) 2024-046555

(51) Int. Cl. B41J 2/165

(52) U.S. Cl. CPC B41J 2/16508; B41P 2235/10

(57) ABSTRACT

A control portion of an inkjet recording apparatus is capable of executing an immersion cleaning mode of performing cleaning of an ink ejection surface by immersing the ink ejection surface in a cleaning liquid stored in a closed space between the ink ejection surface and a cap and heated. In the immersion cleaning mode, based on a lapse of time from an end of ink ejection and an ambient temperature, the control portion predicts a solidified state of residual ink remaining on the ink ejection surface and, based on the predicted solidified state, sets a cleaning condition.

### INCORPORATION BY REFERENCE

This application is based upon and claims the benefit of priority from the corresponding Japanese Patent Application No. 2024-046555 filed on Mar. 22, 2024, the entire contents of which are hereby incorporated by reference.

### BACKGROUND

The present disclosure relates to an inkjet recording apparatus.

Inkjet recording apparatuses, which record images by ejecting ink onto recording media such as paper, are capable of recording high-definition images and thus have been widely used as recording apparatuses such as printers and copy machines. In such an inkjet recording apparatus, ink remaining on ink ejection surfaces of recording heads may become solidified to cause an ejection failure. To address this issue, there are known conventional techniques for removing ink solidified on the ink ejection surfaces, such as capping the ink ejection surfaces, immersing the ink ejection surfaces in a cleaning liquid, and cleaning (wiping) the ink ejection surfaces.

### SUMMARY

An inkjet recording apparatus according to one aspect of the present disclosure includes a recording head, a cap, a cleaning liquid supply portion, a heating portion, a temperature sensing portion, and a control portion. The recording head includes an ink ejection surface having an opening of a nozzle for ejecting ink onto a recording medium. The cap is attachable to and detachable from the ink ejection surface and caps the ink ejection surface. The cleaning liquid supply portion supplies a cleaning liquid to a closed space between the ink ejection surface and the cap. The heating portion heats the cleaning liquid. The temperature sensing portion senses an ambient temperature. The control portion controls operations of the recording head, the cleaning liquid supply portion, and the heating portion. The control portion is capable of executing an immersion cleaning mode of performing cleaning of the ink ejection surface by immersing the ink ejection surface in the cleaning liquid stored in the closed space and heated by the heating portion. In the immersion cleaning mode, based on a lapse of time from an end of ink ejection and the ambient temperature sensed by the temperature sensing portion, the control portion predicts a solidified state of the ink remaining on the ink ejection surface and, based on the predicted solidified state, sets a cleaning condition.

### BRIEF DESCRIPTION OF THE DRAWINGS

FIG. 1 is a schematic sectional front view of an inkjet recording apparatus according to one embodiment of the present disclosure.

FIG. 2 is a plan view of and around a recording portion in the inkjet recording apparatus in FIG. 1.

FIG. 3 is a block diagram showing a schematic configuration of the inkjet recording apparatus in FIG. 1.

FIG. 4 is a side view of a recording head in FIG. 2.

FIG. 5 is a bottom view of the recording head in FIG. 2.

FIG. 6 is a perspective view of the recording portion and a maintenance unit in the inkjet recording apparatus in FIG. 1.

FIG. 7 is a perspective view of a capping unit of the maintenance unit in FIG. 6.

FIG. 8 is an explanatory view showing schematic configurations of the recording head in FIG. 4, the capping unit, and a cleaning liquid supply portion.

FIG. 9 is a graph showing an influence of a temperature of an ink film in a solidified state on a period and a logarithmic decrement of a free damped oscillation waveform in rigid body pendulum-type physical property testing.

FIG. 10 is a graph showing an influence of an immersion time for immersing an ink ejection surface in a cleaning liquid on the period of the free damped oscillation waveform in the rigid body pendulum-type physical property testing.

### DETAILED DESCRIPTION

With reference to the appended drawings, the following describes an embodiment of the present disclosure. The present disclosure is not limited to what is described below.

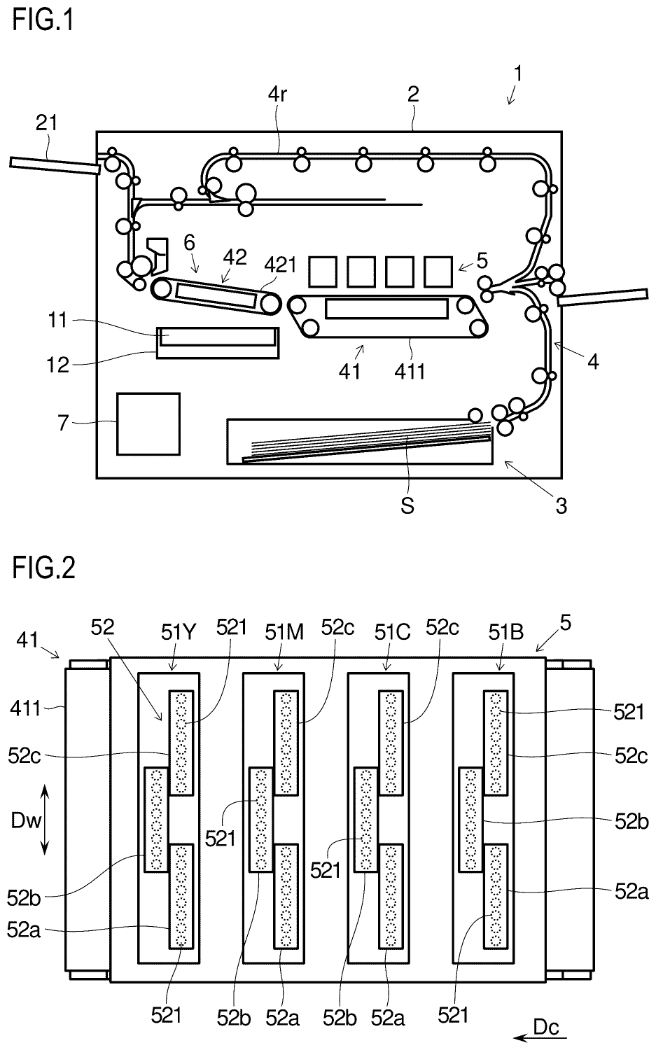

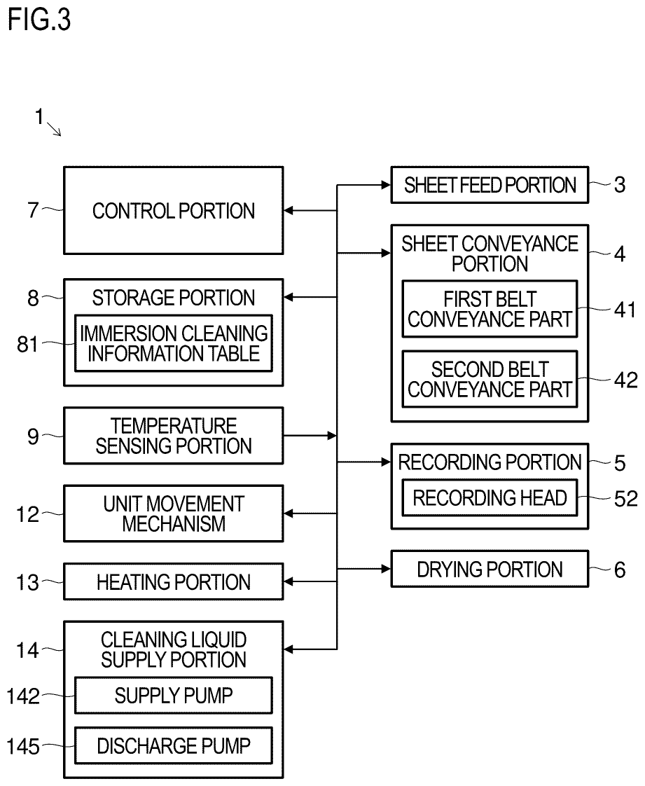

FIG. 1 is a schematic sectional front view of an inkjet recording apparatus 1 according to the embodiment. FIG. 2 is a plan view of and around a recording portion 5 in the inkjet recording apparatus 1 in FIG. 1. FIG. 3 is a block diagram showing a schematic configuration of the inkjet recording apparatus 1 in FIG. 1. The inkjet recording apparatus 1 is, for example, a printer of an inkjet recording type. As shown in FIGS. 1, 2, and 3, the inkjet recording apparatus 1 includes an apparatus main body 2, a sheet feed portion 3, a sheet conveyance portion 4, the recording portion 5, a drying portion 6, a control portion 7, and a storage portion 8.

The sheet feed portion 3 is arranged, for example, in a lower part of the apparatus main body 2. The sheet feed portion 3 contains a plurality of sheets (recording media) S and feeds out the sheets S one by one separately during recording.

The sheet conveyance portion 4 is arranged downstream from the sheet feed portion 3 in a sheet conveyance direction and conveys the sheet S fed out from the sheet feed portion 3. The sheet conveyance portion 4 conveys the sheet S to the recording portion 5 and to the drying portion 6 and further discharges the sheet S that has been subjected to recording and drying to a sheet discharge portion 21. Furthermore, the sheet conveyance portion 4 includes, for example, a reverse conveyance part 4r. In a case of performing duplex recording, the sheet conveyance portion 4 steers the sheet S whose first side has been subjected to recording and drying to the reverse conveyance part 4r and further conveys, again to the recording portion 5 and to the drying portion 6, the sheet S whose conveyance direction has been switched so that front and back sides thereof are reversed.

The sheet conveyance portion 4 includes a first belt conveyance part 41 and a second belt conveyance part 42. The first belt conveyance part 41 includes a first conveyance belt 411 formed to be endless. The second belt conveyance part 42 includes a second conveyance belt 421 formed to be endless. The first belt conveyance part 41 and the second belt conveyance part 42 convey the sheet S while the sheet S is held by suction on upper outer surfaces (upper surfaces) of the first conveyance belt 411 and the second conveyance belt 421, respectively. The first belt conveyance part 41 is arranged below the recording portion 5 and conveys the sheet S. Being positioned downstream relative to the first belt conveyance part 41 in the sheet conveyance direction, the second belt conveyance part 42 is arranged in the drying portion 6 and conveys the sheet S.

The recording portion 5 is positioned downstream from the sheet feed portion 3 in the sheet conveyance direction and is arranged to be opposed to the first belt conveyance part 41. The recording portion 5 is opposed to the sheet S being conveyed while being held by suction on the upper surface of the first conveyance belt 411 and is arranged above the first conveyance belt 411 at a prescribed distance therefrom. That is, the recording portion 5 is opposed to the sheet S being conveyed by the sheet conveyance portion 4.

As shown in FIG. 2, the recording portion 5 holds head units 51B, 51C, 51M, and 51Y corresponding to four different colors of black, cyan, magenta, and yellow, respectively. The head units 51B, 51C, 51M, and 51Y are arranged side by side along a sheet conveyance direction Dc so that a longitudinal direction thereof is parallel to a sheet width direction Dw orthogonal to the sheet conveyance direction Dc. The four head units 51B, 51C, 51M, and 51Y are the same in basic configuration, and thus in the following description, unless particularly required to be limited, identification symbols “B,” “C,” “M,” and “Y” representing the respective colors may be omitted.

Each of the head units 51 of the respective colors includes a line-type inkjet recording head 52. In each of the head units 51 of the respective colors, a plurality of (for example, three (52a, 52b, 52c)) recording heads 52 are arrayed in a staggered manner along the sheet width direction Dw.

The recording head 52 includes a plurality of ink ejection nozzles 521 provided at a bottom part thereof. The plurality of ink ejection nozzles 521 are arranged next to each other along the sheet width direction Dw, and through them, ink can be ejected over an entire recording region on the sheet S. That is, the recording head 52 includes the plurality of ink ejection nozzles 521 for ejecting ink onto the sheet S. The recording portion 5 ejects ink sequentially from the recording heads 52 of the head units 51B, 51C, 51M, and 51Y of the four different colors toward the sheet S being conveyed by the first conveyance belt 411, thus recording a full-color image or a monochrome image on the sheet S.

The drying portion 6 is arranged downstream relative to the recording portion 5 in the sheet conveyance direction, and the second belt conveyance part 42 is provided therein. In the drying portion 6, the sheet S on which an ink image has been recorded in the recording portion 5 is conveyed while being held by suction on the second conveyance belt 421, and ink on the sheet S is dried during this conveyance.

The control portion 7 includes a CPU and other electronic circuits and electronic components (none of them are shown). Based on control programs or data stored in the storage portion 8, the CPU controls operations of various constituent elements provided in the inkjet recording apparatus 1 so as to perform processes related to functions of the inkjet recording apparatus 1. The sheet feed portion 3, the sheet conveyance portion 4, the recording portion 5, and the drying portion 6 individually receive, from the control portion 7, instructions to perform recording on the sheet S in collaboration with each other.

The storage portion 8 is formed of a combination of, for example, a nonvolatile storage device such as a program ROM (read-only memory) or a data ROM and a volatile storage device such as a RAM (random-access memory).

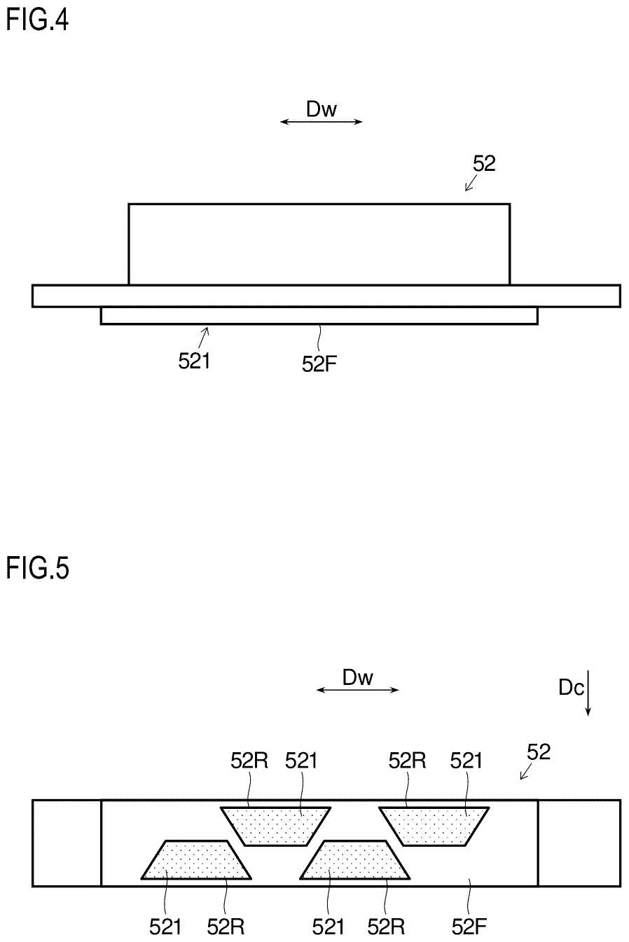

Next, with reference to FIGS. 4 and 5, a description is given of a configuration of the recording head 52 in the recording portion 5. FIGS. 4 and 5 are respectively a side view and a bottom view of the recording head 52 in FIG. 2. The three recording heads 52a, 52b, and 52c of each of the respective colors are identical in shape and configuration, and thus in the following description, identification symbols (a, b, c) are omitted.

The recording head 52 includes an ink ejection surface 52F provided on a lower surface thereof. The ink ejection surface 52F is opposed to a surface (an upper surface) of the sheet S being conveyed on the first conveyance belt 411. As shown in FIG. 5, the ink ejection surface 52F includes a nozzle region 52R in which a multitude of ink ejection nozzles 521 are arrayed. That is, the ink ejection surface 52F has openings of the multitude of ink ejection nozzles 521, through which ink is ejected onto the sheet S. A water-repellent film (not shown) is formed on the ink ejection surface 52F. The recording heads 52 of the four different colors (black, cyan, magenta, and yellow) are individually supplied with inks of four different colors stored in ink tanks external to the head units 51, respectively.

Based on a control signal from the control portion 7 and in accordance with image data received from an external computer, the recording head 52 ejects ink through the ink ejection nozzles 521 toward the sheet S being conveyed while being held by suction on a conveyance surface of the first conveyance belt 411. To be more specific, the control portion 7 inputs, to the recording head 52, an ejection drive signal having a set prescribed drive voltage and a set prescribed pulse width so that the recording head 52 is driven to eject ink through the ink ejection nozzles 521. Thus, on the sheet S on the first conveyance belt 411, there is formed a color image of superimposed inks of four different colors of black, cyan, magenta, and yellow or a monochrome image.

As shown in FIGS. 1 and 3, the inkjet recording apparatus 1 also includes a temperature sensing portion 9, a maintenance unit 11, a unit movement mechanism 12, a heating portion 13, and a cleaning liquid supply portion 14.

The temperature sensing portion 9 senses an ambient temperature around an installation location of the inkjet recording apparatus 1. The temperature sensing portion 9 is formed of, for example, a thermistor.

In a case of not executing a maintenance process with respect to the recording heads 52, as shown in FIG. 1, the maintenance unit 11 is arranged at a first position below the second belt conveyance part 42.

In the inkjet recording apparatus 1, the maintenance process with respect to the recording heads 52 is executed at a predetermined timing. The maintenance process with respect to the recording heads 52 is executed, for example, at a start of recording after an extended period of non-operation or during an interval between recording operations. In a case of executing the maintenance process with respect to the recording heads 52, the control portion 7 controls the unit movement mechanism 12 to move the maintenance unit 11 to a second position below the recording portion 5.

During the maintenance process with respect to the recording heads 52, by a conveyance part movement mechanism (not shown), the first belt conveyance part 41 arranged to be opposed to a lower surface of the recording portion 5 is retracted below a position thereof shown in FIG. 1 to near the sheet feed portion 3. After that, the maintenance unit 11 is moved to the second position below the recording portion 5 and is brought closer to the ink ejection surfaces 52F.

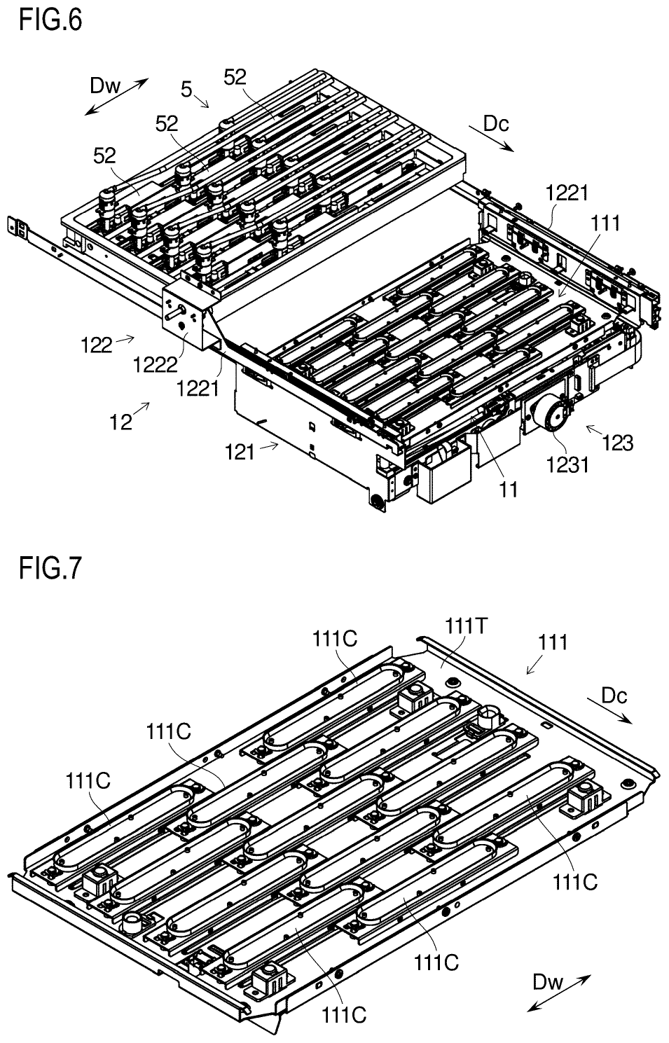

FIG. 6 is a perspective view of the recording portion 5 and the maintenance unit 11 in the inkjet recording apparatus 1 in FIG. 1. FIG. 7 is a perspective view of a capping unit 111 of the maintenance unit 11 in FIG. 6.

The maintenance unit 11 includes the capping unit 111. During the maintenance process with respect to the recording heads 52, the capping unit 111 is arranged at a capping position for capping the ink ejection surfaces 52F and is mounted to the lower surface of the recording portion 5. The capping unit 111 includes a tray 111T and a cap 111C. The tray 111T is formed in a rectangular shape extending horizontally in the sheet conveyance direction Dc and in the sheet width direction Dw.

The cap 111C is arranged on an upper surface of the tray 111T. The cap 111C is arranged at each of positions corresponding to the plurality of recording heads 52a, 52b, and 52c arrayed in a staggered manner along the sheet width direction Dw for each of the respective colors. That is, in this embodiment, the capping unit 111 includes twelve caps 111C. The cap 111C is formed in a downwardly recessed concave shape.

The cap 111C is attachable to and detachable from the ink ejection surface 52F and caps the ink ejection surface 52F. When the capping unit 111 is arranged at the capping position for capping the ink ejection surfaces 52F, the bottom part of the recording head 52 enters an inside of the cap 111C so that a closed space is formed between the ink ejection surface 52F and the cap 111C.

The unit movement mechanism 12 is arranged below either of the recording portion 5 and the drying portion 6. The unit movement mechanism 12 includes a carriage 121, a horizontal movement mechanism 122, and an ascending/descending mechanism 123 and supports the maintenance unit 11.

The carriage 121 is supported to the horizontal movement mechanism 122. The carriage 121 is formed in a rectangular parallelepiped box shape having an open upper surface and houses the maintenance unit 11 inside. The carriage 121 further holds the ascending/descending mechanism 123.

The horizontal movement mechanism 122 includes a guide rail 1221 and a motor 1222.

The guide rail 1221 is arranged on each of one and the other sides of the horizontal movement mechanism 122 in the sheet width direction Dw and extends horizontally from below the recording portion 5 to below the drying portion 6 along the sheet conveyance direction Dc. The maintenance unit 11 is supported to the guide rail 1221 so as to be horizontally movable along the guide rail 1221. The capping unit 111 is independently supported above the carriage 121.

The motor 1222 is arranged adjacently to the guide rail 1221, and an output shaft thereof is linked to the capping unit 111 and to the carriage 121 via a group of gears, a wire and a pulley, or the like (none of them are shown). Upon driving of the motor 1222, the horizontal movement mechanism 122 horizontally moves the capping unit 111 and the carriage 121 along the sheet conveyance direction Dc. The horizontal movement mechanism 122 is capable of horizontally moving the capping unit 111 and the carriage 121 independently of each other.

The ascending/descending mechanism 123 includes a support mechanism (not shown) and a motor 1231. The support mechanism is arranged in an inner bottom part of the carriage 121. The support mechanism supports a bottom part of the maintenance unit 11 and is connected to the motor 1231 via a group of gears, a wire and a pulley, or the like (none of them are shown).

Upon activation of the motor 1231, the ascending/descending mechanism 123 drives the support mechanism to push up or pull down the maintenance unit 11, thus causing the maintenance unit 11 to ascend or descend. That is, the capping unit 111 is caused to ascend or descend by the ascending/descending mechanism 123.

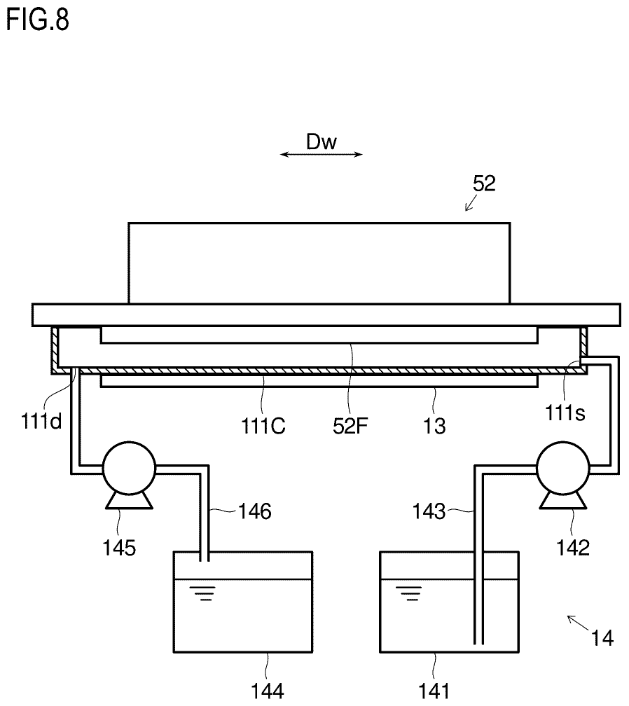

FIG. 8 is an explanatory view showing schematic configurations of the recording head 52 in FIG. 4, the capping unit 111, and the cleaning liquid supply portion 14.

The heating portion 13 is individually affixed to an outer bottom surface of each of the plurality of caps 111C of the capping unit 111. The heating portion 13 is formed of, for example, a plate-shaped heater. The heating portion 13 heats the cap 111C. In other words, via the cap 111C, the heating portion 13 heats a cleaning liquid stored in the cap 111C. An operation of the heating portion 13 is controlled by the control portion 7.

The cleaning liquid supply portion 14 supplies the cleaning liquid to the closed space between the ink ejection surface 52F and the cap 111C. The cleaning liquid supply portion 14 includes a cleaning liquid tank 141, a supply pump 142, a supply tube 143, a waste liquid tank 144, a discharge pump 145, and a discharge tube 146.

The cleaning liquid tank 141 is connected to the cap 111C via the supply tube 143. The supply tube 143 is connected to the cap 111C, and the cap 111C has a supply port 111s through which the cleaning liquid flows into the cap 111C.

The cleaning liquid tank 141 contains the cleaning liquid to be supplied into the cap 111C. The supply pump 142 is arranged downstream relative to the cleaning liquid tank 141 in a cleaning liquid supply direction. The supply pump 142 sucks the cleaning liquid in the cleaning liquid tank 141 and ejects it toward the cap 111C. An operation of the supply pump 142 is controlled by the control portion 7.

The waste liquid tank 144 is connected to the cap 111C via the discharge tube 146. The discharge tube 146 is connected to the cap 111C, and the cap 111C has a discharge port 111d through which the cleaning liquid in the cap 111C flows out.

The waste liquid tank 144 contains a used cleaning liquid (a waste liquid) that has been supplied into the cap 111C and used for cleaning of the ink ejection surface 52F. The discharge pump 145 is arranged upstream relative to the waste liquid tank 144 in a cleaning liquid discharge direction. The discharge pump 145 sucks the cleaning liquid (the waste liquid) in the cap 111C and ejects it toward the waste liquid tank 144. An operation of the discharge pump 145 is controlled by the control portion 7.

Further, the control portion 7 is capable of executing an immersion cleaning mode of performing cleaning of the ink ejection surface 52F by immersing the ink ejection surface 52F in the cleaning liquid stored in the closed space between the ink ejection surface 52F and the cap 111C and heated by the heating portion 13. In this way, the inkjet recording apparatus 1 removes residual ink remaining and solidified on the ink ejection surface 52F.

Moreover, in the immersion cleaning mode, based on a lapse of time from an end of ink ejection and an ambient temperature sensed by the temperature sensing portion 9, the control portion 7 predicts a solidified state of residual ink remaining on the ink ejection surface 52F and, based on the predicted solidified state of the residual ink, sets a cleaning condition. That is, with respect to the immersion cleaning mode, the inkjet recording apparatus 1 sets a cleaning condition enabling removal of ink solidified on the ink ejection surface 52F.

According to the above-described configuration, it is possible to set, based on a solidified state of residual ink remaining on the ink ejection surface 52F of the recording head 52, a cleaning condition enabling removal of the solidified ink and to execute the immersion cleaning mode under the cleaning condition. Thus, it is possible to remove ink solidified on the ink ejection surface 52F to a satisfactory degree. That is, in the inkjet recording apparatus 1, it becomes possible to improve cleaning performance for cleaning the ink ejection surface 52F of the recording head 52 and thus to favorably maintain ink ejection performance.

Next, a detailed description is given of a prediction on a solidified state of residual ink remaining on the ink ejection surface 52F and setting, based on the prediction, of a cleaning condition for the immersion cleaning mode. In setting the cleaning condition for the immersion cleaning mode, the inkjet recording apparatus 1 uses a result of rigid body pendulum-type physical property testing performed beforehand and sets the cleaning condition based thereon.

The rigid body pendulum-type physical property testing is physical property testing enabling an evaluation of a change over time in physical properties of a substance in a course of curing and drying from a solution state to a solid state. A rigid body pendulum-type physical property testing technique has been adopted in International Standard ISO 12013-1 entitled “Method for Measuring Curing Start Temperature of Paints and Varnishes” and International Standard ISO 12013-2 entitled “Method for Measuring Thermal Properties (Tg, Hardness) of Coatings and Varnishes.” According to this testing technique, based on an influence of a material on a free damped oscillation of a rigid body pendulum, physical properties of the material such as a curing property can be easily evaluated.

Further, with regard to the prediction on a solidified state, the control portion 7 includes an immersion cleaning information table 81 (see FIG. 3) indicating a relationship of a lapse of time from an end of ink ejection and an ambient temperature with a free damped oscillation waveform in the rigid body pendulum-type physical property testing. The immersion cleaning information table 81 may be included in the control portion 7 or may be stored beforehand in the storage portion 8 as shown in FIG. 3.

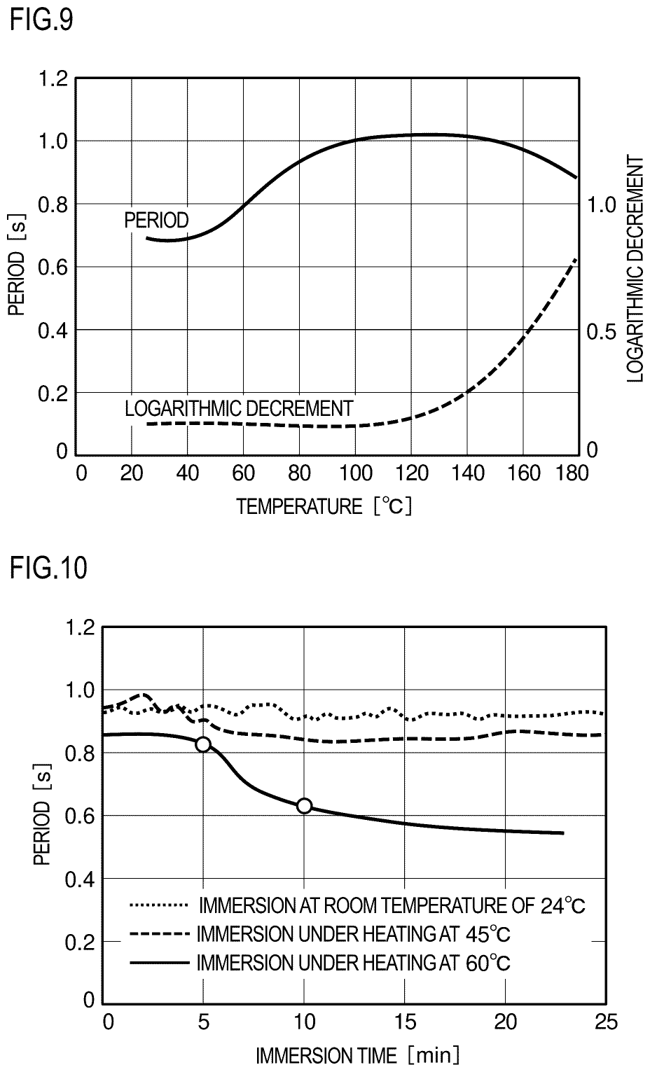

The immersion cleaning information table 81 is generated beforehand based on a graph shown in FIG. 9, which illustrates a result of the rigid body pendulum-type physical property testing. In the rigid body pendulum-type physical property testing performed beforehand, there are evaluated physical properties of an ink film formed on a surface of ink in a solidified state. To be more specific, there are evaluated a change in period of a free damped oscillation waveform of the ink film and a change in logarithmic decrement thereof. A change in the period might affect a change in state of a surface of the ink film, and a change in the logarithmic decrement might affect a change in viscosity of the ink film.

FIG. 9 is the graph showing an influence of a temperature of an ink film in a solidified state on a period and a logarithmic decrement of a free damped oscillation waveform in the rigid body pendulum-type physical property testing. In FIG. 9, a horizontal axis indicates the temperature of the ink film, a left vertical axis indicates the period of the free damped oscillation waveform, and a right vertical axis indicates the logarithmic decrement of the free damped oscillation waveform.

According to FIG. 9, when the ink film is at a temperature of 40° C. or higher, the period of the free damped oscillation waveform increases, and this indicates a tendency of a surface of the ink film to soften. Furthermore, when the ink film is at a temperature of 120° C. or higher, the logarithmic decrement of the free damped oscillation waveform increases, i.e. the waveform converges quickly and there occurs an increase in viscosity, and this indicates the tendency of the surface of the ink film to soften. Accordingly, based on the immersion cleaning information table 81, the control portion 7 sets a cleaning condition so that there occurs a prescribed change in the period or the logarithmic decrement of the free damped oscillation waveform in the rigid body pendulum-type physical property testing.

According to the above-described configuration, a cleaning condition for the immersion cleaning mode can be set so that an ink film in a solidified state on the ink ejection surface 52F exhibits a tendency to soften. The cleaning condition can be set based on physical property testing performed beforehand on ink in a solidified state, and thus it becomes possible to remove ink solidified on the ink ejection surface 52F to a satisfactory degree.

FIG. 10 is a graph showing an influence of an immersion time for immersing the ink ejection surface 52F in a cleaning liquid on the period of the free damped oscillation waveform in the rigid body pendulum-type physical property testing. In FIG. 10, a horizontal axis indicates the immersion time for immersing, in the cleaning liquid, the ink ejection surface 52F with residual ink in a solidified state remaining thereon, and a vertical axis indicates the period of the free damped oscillation waveform.

With regard to FIG. 10, as a sample, there was prepared the ink ejection surface 52F with residual ink remaining thereon at an ambient temperature of 40° C. and after a lapse of 96 hours from an end of ink ejection, and the rigid body pendulum-type physical property testing was performed on the sample. As shown in FIG. 10, by the heating portion 13, the cleaning liquid was heated to temperatures of 45° C. and 60° C.

According to FIG. 10, in a case where the sample was immersed in the cleaning liquid at room temperature (24° C.), even when the immersion time elapsed, no change was observed in the period of the free damped oscillation waveform, and thus it cannot be said that some change had occurred in an ink film in a solidified state. Similarly, also in a case where the sample was immersed in the cleaning liquid at the temperature of 45° C., even when the immersion time elapsed, no significant change was observed in the period of the free damped oscillation waveform, and thus it cannot be said that a change had occurred in the ink film in the solidified state.

In contrast to the above-described cases, in a case where the sample was immersed in the cleaning liquid at the temperature of 60° C., as the immersion time elapsed, there occurred a significant change in the period of the free damped oscillation waveform, and thus it can be said that a change had occurred in the ink film in the solidified state. According to this test result, at an immersion time of 5 minutes when the free damped oscillation waveform had a period of 0.8 [s], a rigid body pendulum being in contact with the ink became likely to slip, so that peeling of the ink film that used to be in the solidified state was started. At an immersion time of 10 minutes when the free damped oscillation waveform had a period of 0.6 [s], the peeling (dissipation) of the ink film that used to be in the solidified state was completed.

Thus, the control portion 7 preferably sets a cleaning condition so that a change of not less than 0.1 [s] from an initial value prior to immersion cleaning occurs in the period of the free damped oscillation waveform in the rigid body pendulum-type physical property testing. According to this configuration, it becomes possible to cause an ink film in a solidified state on the ink ejection surface 52F to soften and dissipate. Accordingly, it is possible to remove ink solidified on the ink ejection surface 52F to a satisfactory degree.

Furthermore, in setting a cleaning condition for the immersion cleaning mode, the control portion 7 preferably sets, to a prescribed value, at least one of a heating temperature for heating the cleaning liquid and the immersion time. According to this configuration, in accordance with structures of the recording head 52, the ink ejection surface 52F, and so on, a required time to perform the immersion cleaning mode, physical properties of the cleaning liquid, and so on, a cleaning condition for the immersion cleaning mode can be set so that an ink film in a solidified state on the ink ejection surface 52F exhibits a tendency to soften. That is, the cleaning condition for the immersion cleaning mode can be freely set as appropriate in accordance with specifications of the inkjet recording apparatus 1. Accordingly, in any of a wide variety of types of inkjet recording apparatuses as the inkjet recording apparatus 1, it becomes possible to improve the cleaning performance for cleaning the ink ejection surface 52F of the recording head 52 and thus to favorably maintain the ink ejection performance.

While the foregoing has described the embodiment of the present disclosure, the present disclosure is not limited in scope thereto and can be implemented in variously modified forms without departing from the spirit of the disclosure.

What is claimed is:

1. An inkjet recording apparatus, comprising:
a recording head that includes an ink ejection surface having an opening of a nozzle for ejecting ink onto a recording medium;
a cap that is attachable to and detachable from the ink ejection surface and caps the ink ejection surface;
a cleaning liquid supply portion that supplies a cleaning liquid to a closed space between the ink ejection surface and the cap;
a heating portion that heats the cleaning liquid;
a temperature sensing portion that senses an ambient temperature; and
a control portion that controls operations of the recording head, the cleaning liquid supply portion, and the heating portion,
wherein
the control portion is capable of executing an immersion cleaning mode of performing cleaning of the ink ejection surface by immersing the ink ejection surface in the cleaning liquid stored in the closed space and heated by the heating portion, and
in the immersion cleaning mode, based on a lapse of time from an end of ink ejection and the ambient temperature sensed by the temperature sensing portion, the control portion predicts a solidified state of the ink remaining on the ink ejection surface and, based on the predicted solidified state, sets a cleaning condition.

2. The inkjet recording apparatus according to claim 1, wherein
with regard to prediction on the solidified state, the control portion includes an immersion cleaning information table indicating a relationship of the lapse of time and the ambient temperature with a free damped oscillation waveform in rigid body pendulum-type physical property testing, and
based on the information table, the control portion sets the cleaning condition so that there occurs a prescribed change in period or logarithmic decrement of the free damped oscillation waveform.

3. The inkjet recording apparatus according to claim 2, wherein
the control portion sets the cleaning condition so that a change of not less than 0.1 [s] from an initial value prior to immersion cleaning occurs in the period of the free damped oscillation waveform.

4. The inkjet recording apparatus according to claim 3, wherein
in setting the cleaning condition, the control portion sets, to a prescribed value, at least one of a heating temperature for heating the cleaning liquid and an immersion time for immersing the ink ejection surface.
